(19) United States
(12) Patent Application Publication
(10) Pub. No.: US 2009/0101556 A1
(43) Pub. Date: Apr. 23, 2009

(54) REACTOR AND METHOD FOR DECALCIFYING WATER AND SIMULTANEOUS REMOVAL OF POLLUTANTS

(76) Inventor: Massoud Karimnia, Hamburg (DE)

Correspondence Address: SAND & SEBOLT, AEGIS TOWER, SUITE 1100, 4940 MUNSON STREET, NW, CANTON, OH, 44718-3615, US

(21) Appl. No.: 12/294,279

(22) PCT Filed: Mar. 27, 2006
(86) PCT No.: PCT/EP06/02773

§ 371 Date: Sep. 24, 2008

(51) Int. Cl. C02F 5/02; C02F 1/02

(52) U.S. Cl. 210/179; 210/687

(57) ABSTRACT

The invention relates to a reactor and a method for decalcifying water and simultaneous removal of pollutants as well as reduction of the turbidity and disinfection. Such a reactor and method are known from DE 102 47 686.1. Compared with this state of the art, the invention intends to design the reactor and the method in such a way that they can be used for all ways of working and orders of magnitude as far as possible. In other words: the greatest possible variability with regard to process guidance and the quantities of water to be treated is to be achieved.

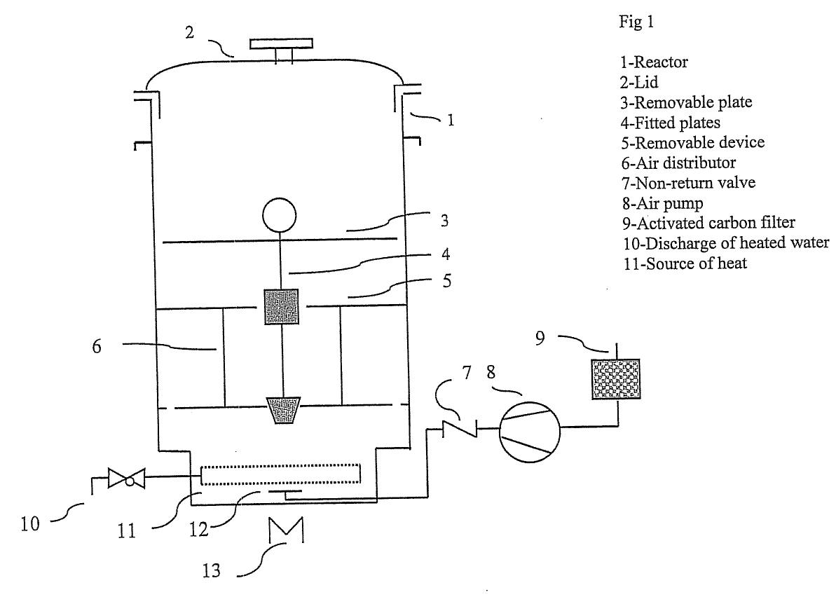

This task is solved by the reactor, wherein the fitted plates manifest a bore in the middle of each of them, through which a device for opening and closing of the bores by means of conical and/or cylindrical closures passes, the upper end of the device being without a plate or being connected with one or more non-fitted plate(s) and manifesting a holder and one or more of the fitted plates possessing circumferential openings in the edge area and one or more further fitted plate(s) not having circumferential openings and the direct heating devices and aerating tubes being arranged in the sections of the reactor at a distance from one another and the feed and/or discharge for the water being arranged in the upper and/or lower area of the reactor and with a plate with only one large bore in the middle being attached above a plate with small bores at the edge or by the method according to Claim 6 (FIG. 1), with an additional discharge tap also being possibly provided for the removal of residues.

The invention relates to a reactor and a method for decalcifying water and simultaneous removal of pollutants as well as reduction of the turbidity and disinfection in a reactor with feed and discharge without the additional of chemicals and filters according to the generic term of Claim 1.

Such a reactor and method are principally known from DE 10247686.

Further, calcium hydrate precipitation, inoculation devices for formation of calcium carbonate and ion exchangers are well known for decalcifying water. These methods are chemical processes. But there are also methods working on a physical basis. This also includes decalcification by changing the crystal structure in the magnetic field, e.g. DE 43 36 388, cavitation, reverse osmosis, membrane filtration. Further, there are thermal processing methods, e.g. U.S. Pat. No. 5,858,248, which achieves decalcification and elimination of pollutants by hydrodynamic optimisation of the reactor to heat the water.

In patent DE 102 47 686 and publication WO 2004/035487 A1, not only the hydrodynamic situation in the reactor is optimised, but the water is simultaneously aerated. This results in a more effective decalcification and elimination of pollutants, also below the boiling point of the water.

For all the named processes, a positive influence on removal of scale or prevention of scale formation in installations is mainly certified. In the thermal process, a simultaneous reduction of scale, drop in turbidity and elimination of pollutants in the water is made possible. The detriment in these processes, however, is the fact that either the technique is complicated and can only be practicable and profitable for larger amounts of water or that the technique is not practical and effective enough.

The disadvantage of thermal processes (see U.S. Pat. No. 5,858,248) is for example that the turbulence and mixing of the water up to the boiling point of the water is low, which is why simultaneous decalcification, elimination of pollutants and removal of volatile pollutants can only be done effectively with the help of this process at boiling point with long further heating at this temperature. To this extent, this process can, for example, not be used for decalcification of the water for use in hot-water installations, where the water is heated to about 70° C., due to the high costs. Further, it works with the help of a filter cartridge, which has to be replaced and regenerated externally when it is worn out. Further, this process is only suited for the cases in which production of oxygen-free water is required. Oxygen-free water may well be a benefit for production, but it is not beneficial for health. And last, it is suited for treatment of major quantities of water in industry as a result of the relatively complicated design of the system, but is less suited for household use and similar.

The disadvantages of the aforementioned US patent have partly been remedied by patent DE 10247689, but this technique does not work effectively as an intensive micro-mixing of the water takes place practically only below the first plate in the direct vicinity of the source of heat and only on the reactor wall for further plates. Accordingly, the treatment of the water takes longer. As the plates are further not fitted to the reactor wall and can be removed from the reactor, additional heating and aeration between the plates and within the reactor are ruled out. Finally, the plates are fitted to the lid with one or two rods, for which reason manual re-filling the devices, which work discontinuously, with water is only possible when the lid is removed from the treatment area together with the plate(s). With hot water and on larger devices, this causes problems.

The techniques which work with the help of ion exchangers, activated carbon filters and similar absolutely need electrical energy on the one hand and are very sensitive towards sediments in the water and block very easily on the other hand, with the result that they are only suited as a rule for processing clear tap water, especially for use in the household area. Otherwise, the water has to be pre-treated externally.

The task of the invention in question is to improve the aforementioned reactor and process in such a way that it can avoid the problems described even without the use of chemicals and filters and decalcify water without great requirements of apparatus and maintenance, simultaneously eliminate pollutants from the water, reduce the turbidity of the work and result in disinfection. A further objective is to release scale deposits from the heat transmission surfaces both in continuous and also dis- and semi-continuous reactor devices and not to lead to a permanent formation of a crust. The reactor in accordance with the invention ought to be produced as far as possible in all sizes from 0.5 litres upwards and make variable process guidance possible.

The task and the objective are solved with a view to the appliance by the reactor identified in Claim 1 and with a view to the process by the process according to Claim 6.

The flow in the heating of water is more or less laminar and more or less takes place in the internal area of the water. As a result of the firmly fitted plates, provided with bores, in the plates in the reactor with aeration, the laminar flow is converted into a turbulent flow in the invention on the one hand. This results in an intensive micro-mixing of the water in all areas of the reactor. Alongside this, the turbulence is guided as far as possible into the vicinity of the phase limit surface (reactor wall), in order to enlarge the exchange of substances there and to accelerate the heterogeneous formation of seed crystals. The heterogeneous and secondary seed formation take place at lower oversaturation. On the other hand, the firmly fitted plates and their specific arrangement result in sequential areas in the reactor in which the water temperature in the vicinity of the source of heat rises more quickly than in other areas. In such a case, the temperature differences between individual areas are a multiple of 10° C. As a result, there is a faster formation of seeds and crystal growth there. As a result of these seeds and crystals, which later partly penetrate into other areas, there is an automatic inoculation and secondary crystallisation in remaining areas, leading to a quicker sequence of the process all told together with heterogeneous formation of seeds and crystals.

The crystallisation of hardness minerals in water is precipitation crystallisation. As is known, crystallisation generally takes place more quickly by inoculation by related crystals. In precipitation crystallisation specifically, the crystallisation only commences at a higher oversaturation, with heterogeneous seed formation playing a larger role than homogeneous. The seed formation and the crystal growth are additionally supported by the suitable material with large surface energy between the reactor wall and water. There are reports that gas bubbles as outside particles also support heterogeneous seed formation. Not only macro-, but also micro-mixing of the reaction partners has a positive effect on seed formation in precipitation crystallisation. In the precipitation of carbonates in water, quick stripping of the carbon dioxide from the water also plays a role. Aeration and production of intensive mixing zones underneath the plates with simultaneous desorption of the carbon dioxide result in the crystallisation beginning at a considerably lower oversaturation than is otherwise the case and a long way below the boiling point.

In the process according to patent DE 10247686, an intensive micro-mixing practically only takes place underneath the first plate and in the process according to U.S. Pat. No. 5,858,248 quick stripping of the carbon dioxide is only made possible at the boiling point.

Stripping of the carbon dioxide and crystallisation at lower oversaturation further mean that more carbon dioxide and thus carbonates are removed from the water. This effect for its part means that the pH value of the water rises higher than in decalcification in conventional reactors with the help of this process. A higher pH value leads to an increase in carbonate precipitation, with these two factors together finally leading to a better physical and chemical precipitation of sediments, phosphates and hydroxides of metal and heavy metal.

For these reasons, the process in suited not only to the treatment of tap water, but also to the treatment of surface and ground water with a high share of sediments as well as some waste waters.

It is known that oversaturation of hardness minerals is achieved more easily on warmer contact surfaces (heating surface and reactor wall) for seed formation than in water and that crystallisation of these salts primarily takes place on these surfaces. Although the deflection of the water flow to the vicinity of the reactor wall results in the laminar layer in this area becoming smaller and the exchange of material and energy being favoured, it is however seen in practice that, alongside a micro-mixing to the reactor walls, this also plays an important role in other areas of the water in crystallisation. As a result of an optimised arrangement of the plates and the possibility of a faster sequential heating and inoculation of further areas together, prerequisites for a better use of the reactor and the energy to be fed can be created.

In the reactors with moving plates or cartridges, it is only possible to further the crystallisation in further areas by an additional lateral heating of the reactor. However, the loss of heat in this context is very high compared with direct heating in water—e.g. by an electric heating spiral—. The possibility of a direct heating exists in the reactor with firmly fitted plates. The same also applies to the feed of air.

Depending on the desired objectives in treatment, the water is not only heated and aerated, but if necessary either its temperature is kept constant by lower provision of heat than before in this range of temperatures and/or the aeration is continued for a longer period.

As a result of the possibility of sequential heating according to the invention and earlier boiling of the water in the immediate vicinity of the source of heat, water vapour occurs in this area, rising through the bores on the edge of the fitted plates in the form of small bubbles and likewise contributing to a micro-mixing of the water in the upper area. In other words, if aeration is not possible or not desirable for certain reasons, a considerable effect can nevertheless be achieved in the reactor with a slight delay. This possibility is not optimal in the aforementioned thermal methods.

In the aforementioned thermal methods, there is also a certain sequential heating and formation of vapour in the immediate vicinity of the source of heating; however, vapour and air rise in the form of large bubbles, which, unlike small bubbles, do not effectively lead to a mixing of the water and an exchange of material, even if air distributors are used in the reactor in the method in patent DE 10247686. The reasons are on the one hand that the surface tension of the water drops with a rise in temperature and thus the bubbles are formed too large, mainly as a result of coalescence. The plates further contribute to the small air bubbles colliding and forming larger bubbles.

This problem is solved in the reactor according to the invention by means of firmly fitted plates in such a way that the large bubbles are made smaller to form small homogeneous bubbles when passing through the small bores on the edge of the plate and rise in a fine distribution in the vicinity of the reactor wall. But the plate fitted above this only has one large bore in the middle, however none at the edge. In this way, the bubbles are steered in the middle of this phase when they rise, resulting in an intensive mixing in this area as well.

As far as the reactor material with a view to the precipitation crystallisation is concerned, the seed forming work is reduced on surfaces with a good wettability by water and higher surface energy of the contract surface.

A further function of the firmly fitted plates and the plate(s) not fitted to the reactor wall is that the scale deposits do not form adherent growing crystals, but loose (amorphous) and layered crystals, which have a lower adhesive capacity, as a result of the intensive mixing and possible boiling of the water. In a turbulent flow, tensions occur, loosening the crystals from time to time and passing them on to the water. In this way, a calcification of the reactor is avoided and the passage of heat as a result of calcification of the heating surface is not reduced. Finally, heating the water above 70° C. also acts as a secure method of sterilising the water and killing off the legionellae in the water.

The simplest version of this appliance according to the invention is a discontinuous or semi-continuous device or reactor heated and aerated from below with the help of an external source of energy. In the treatment area of this reactor, two plates at a distance to the floor for segmental heating of the water and steering of the flow as well as reinforcement of the turbulence on the reactor wall and micro-mixing within the water have been fitted. The plates have been arranged horizontally. The lower plate has small bores going around the edge and a large bore in the middle. The second plate only has one large bore. To start with, the reactor is filled with water from the top. After this, a device comprising a plate and cylindrical or conical metal parts, which are fitted centred to a holder, are inserted into the bores in such a way that the lowest central bore is completely closed and the upper bore is closed at a distance.

The plates can also be fitted in the reactor by them being connected with one another beforehand with the help of two or three rods and then being pushed into the reactor together, so that they can also be pulled out again if necessary.

The moving upper plate contributes on the one hand to the micro-mixing of the water above the fitted plates and on the other hand to the attenuation of the boiling process in this area. When the water is poured out after the treatment, the residues remain on the plates and the base of the reactor. The residues are removed after multiple treatment of the water by tipping the container over. For this, the device is removed from the middle of the reactor. In this way, the reactor in accordance with the invention needs no further maintenance or similar with the exception of simple removal of the residues.

To reduce the volume of the water remaining in the treatment area, the latter has been narrowed somewhat at the bottom for discontinuous or semi-continuous operation.

During the treatment, sediments float in the water. If it is possible to remove the water from the reactor even during the treatment or the boiling, a screen connected to the discharge tap will prevent it from flowing out.

Depending on the task, the water treated in this way can be removed from the treatment area for decalcification and reduction of the pollutants immediately after treatment or removal can only be necessary after cooling off in the treatment area, as compounds frequently have lower solubility at low temperatures.

Further advantages and features can be seen from the sub-claims, which can also be of significance for the invention together with the main claim. Below, preferred embodiments of the invention are explained on the basis of the diagram for better understanding. It should be clear that the invention is not limited to the examples shown.

We see:

FIG. 1 a schematic cross-sectional view through a reactor according to the invention in its simplest embodiment, manifesting the fitted plates and a removable device as well as an aerating device (the reactor in FIG. 1 is preferably suited for discontinuous treatment of water from 2 to about 50 litres);

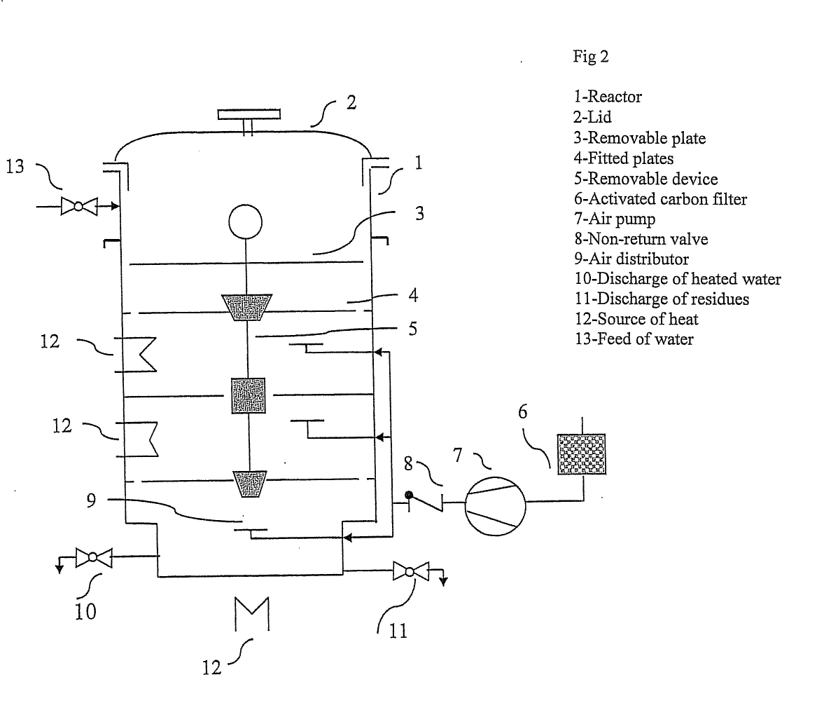

FIG. 2 a schematic portrayal of a further embodiment of a reactor according to the invention for dis- or semi-continuous operation with additional heating and aerating in various areas as well as a further discharge tap for removal of residues (the reactor in FIG. 2 is preferably suited for discontinuous or semi-continuous treatment of water from 10 litres up to a number of cubic metres);

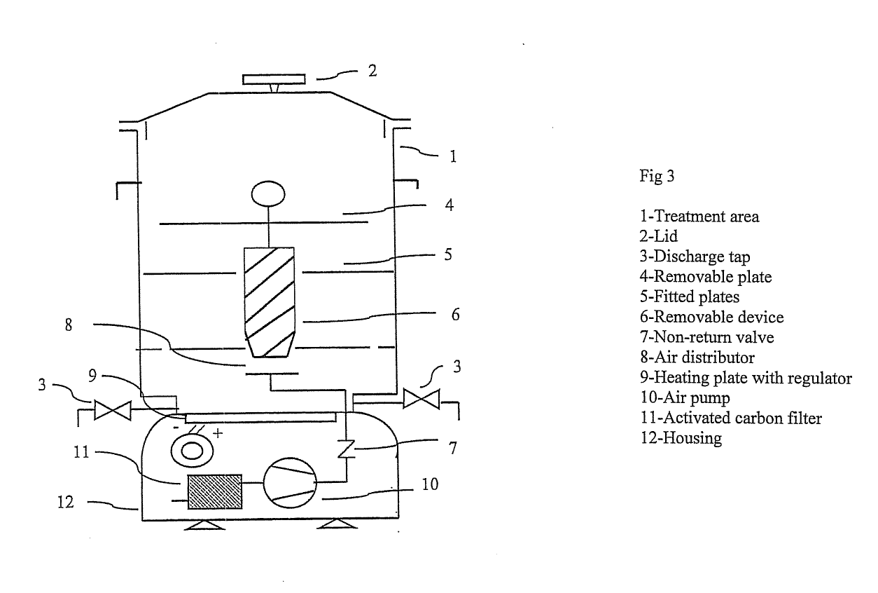

FIG. 3 a schematic portrayal of a further embodiment of a reactor according to the invention for dis- or semi-continuous operation with integrated heating and aerating as well as a further discharge tap for removal of residues (the reactor in FIG. 3 is preferably suited for discontinuous or semi-continuous treatment of water from 2 to about 100 litres);

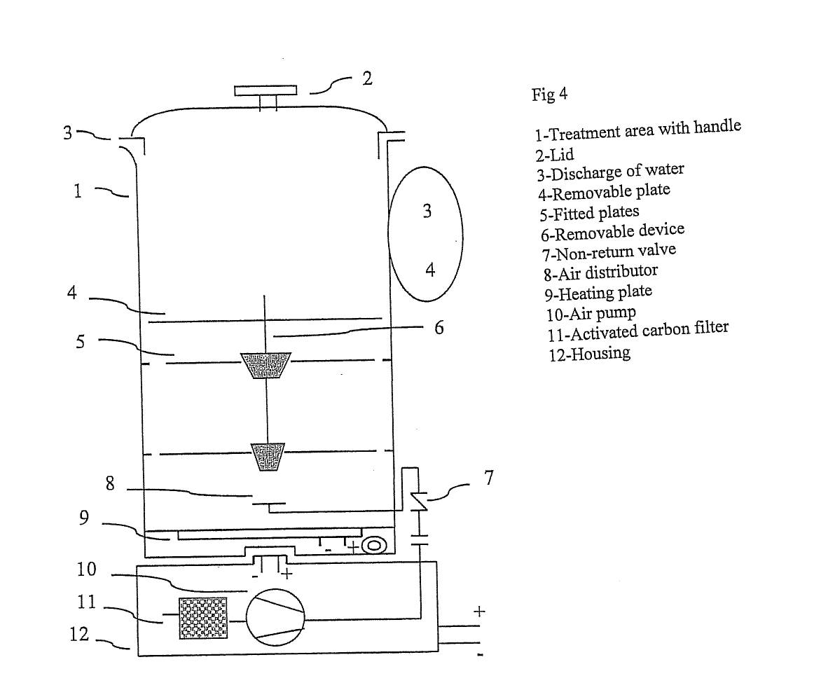

FIG. 4 a schematic portrayal of a further embodiment of a reactor according to the invention without a discharge tap, with integrated heating, aeration and removable container as well as separable container and aeration tube, in which the water is poured out from above after the treatment, for which all the plates in the discharge area have additional bores (the reactor in FIG. 4 is preferably suited for discontinuous treatment of water from 1 to about 3 litres);

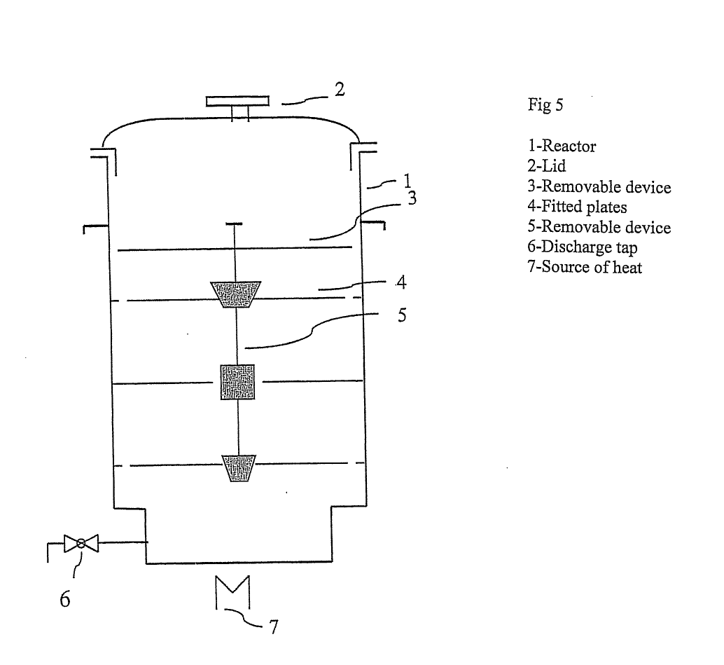

FIG. 5 a further embodiment of a reactor according to the invention without aeration with a discharge tap (the reactor in FIG. 5 is preferably suited for discontinuous treatment of water from 2 to about 20 litres);

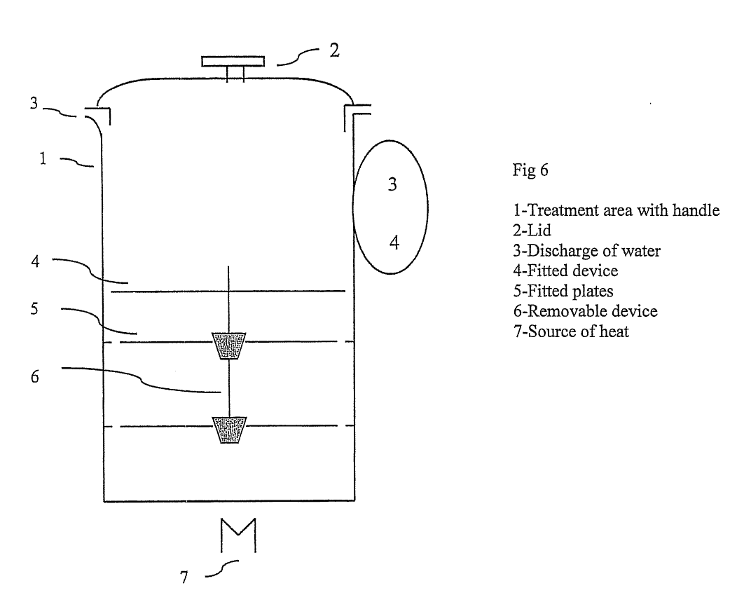

FIG. 6 a further embodiment of a reactor according to the invention without aeration and without a discharge tap (the reactor in FIG. 6 is preferably suited for discontinuous treatment of water from 0.5 to about 3 litres);

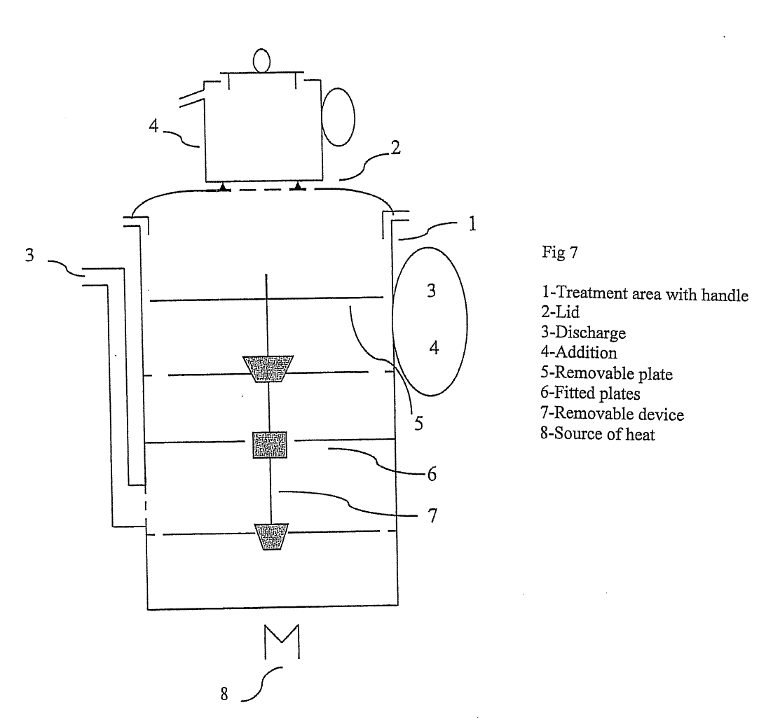

FIG. 7 a further embodiment of a reactor according to the invention with a discharge pipe, without aeration for treatment of the water and keeping hot beverages hot (the reactor in FIG. 7 is preferably suited for discontinuous treatment of water from 1 to about 2.5 litres);

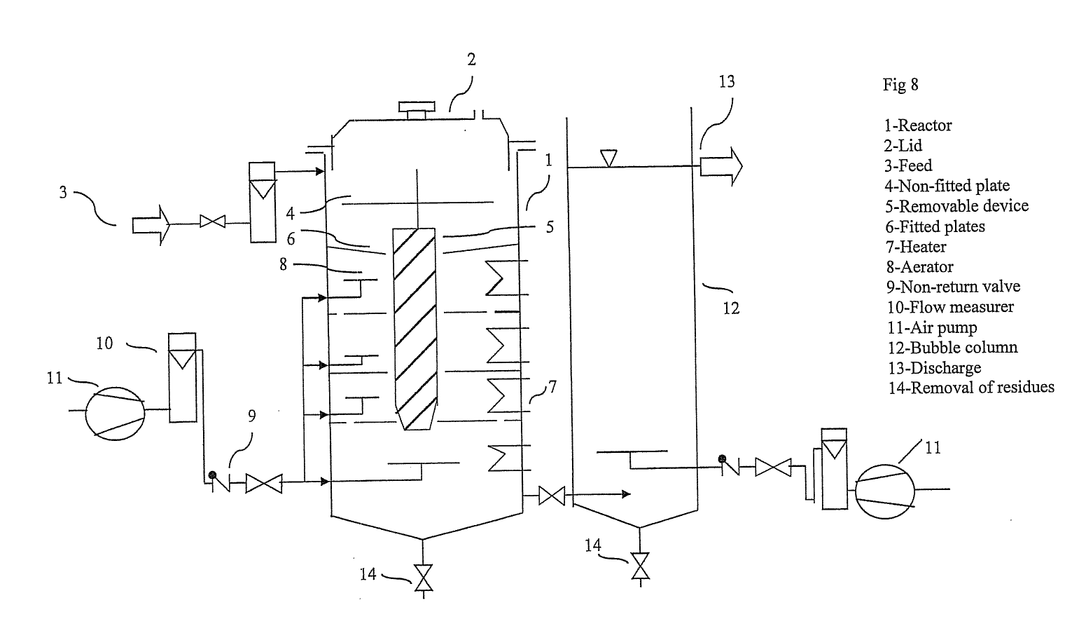

FIG. 8 a schematic portrayal of a further embodiment of a reactor according to the invention for continuous operation with a number of fitted plates, additional heating and aeration to various segments and a downstream bubble column (the reactor in FIG. 8 is preferably suited for treatment of water from 10 litres/h to a number of cubic metres/h).

FIG. 1 represents the simplest embodiment of the reactor, comprising the following parts: the treatment area 1, lid 2, the non-fitted plate 3, connected with the removable device 4, the fitted plates 5, rods to fit the plates 6, the non-return valve 7, the aeration pump 8, the activated carbon filter 9, the discharge tap 10, the screen 11, air distributor 12, which can be heated from below with the help of external sources of energy 13, and can be topped up with water by hand.

FIG. 2 shows a further reactor for dis- or semi-continuous operation, which can additionally be filled with water from above, additionally heated to each segment and aerated via a second valve.

In FIGS. 3 and 4, two further reactors with their own electrical heating and electrical regulator 9 and a housing as a stand can be seen, the reactor either being fitted firmly on the stand with the pouring out of the water through the discharge being facilitated by an increase of the distance of the treatment area from the base or being removable from the stand.

In FIG. 3, the aeration pump 10, activated carbon filter 11, heating and regulator 9 are all integrated in housing 12 under the treatment area.

In FIG. 4, the heating plate and regulator 9 under the removable reactor, the aeration pump 10 and activated carbon filter 11 are integrated in housing 12 under the treatment area. In this reactor, the treated water can be poured out from the top by tipping the reactor.

The scales for larger reactors for dis- and semi-continuous operation can be enlarged at will complying with the aforementioned optimisations, heated and aerated in every phase and the number of plates increased. To save energy, the treatment area can also be provided with insulation material and the loss of heat thus reduced.

In FIGS. 5, 6 and 7 the reactors in FIG. 1, FIG. 3 and FIG. 4, which can be heated externally, are shown without aeration. They can be used if no electrical current for operation of the air pump is available or desired. If necessary, additional heat energy can be added in order to treat the water at the boiling point for some time.

For continuous operation of the device according to the invention, the system comprises a reactor and a bubble column, where the water is only further aerated after treatment in the first reactor (FIG. 8). The reactor has been provided with a number of horizontal plates on the inside, can be double-walled and additionally be heated and aerated to each level. In this reactor, the water is heated up to the desired temperature and simultaneously aerated. After this, the water goes into a bubble column, where the water is only aerated. If use of the bubble column is not possible for any reason, the process can be carried out without it, but with a somewhat longer retention time in the first reactor.

Further fields of use of the reactor and method according to the invention without or with use of chemicals are, for example, drinking water, surface water and waste water processing as well as sludge treatment in general.

So if a thermal treatment of water for elimination of pollutants in the reactor developed according to the invention is not sufficient, chemicals and gases (e.g. pure oxygen or ozone) can be added to the water if needed.

It is also possible to attach a firmly fitted UV radiator to each level of the treatment area in order to enable or accelerate oxidation of further pollutants.

Basically, the thermal reactor according to the invention is a high-performance reactor for chemical reaction management, which can also be used in other areas of chemical reaction management.

The method can be used to save chemicals as a sensible preliminary to micro-, ultra-, nano-filtration and in particular reverse osmosis.

Heating of the treatment room can be done not only electrically, but also by a corresponding change with the help of fossil or renewable sources of energy. To this extent, the reactor according to the invention can generally be used for treatment of water in general for decentralised drinking water processing for consumers and above all in regions without electrical energy connection and catastrophe areas.

Further, the following features alone or also together can be significant for the invention:
that fossil fuels and renewable energies can be used to heat the water with an integrated heating device with corresponding amendment of the heating device,
that a gas pump with controllable throughflow is used for agitation, aeration, stripping and chemical oxidation,
that aeration and heating can take place in various areas in the reactor
that the plates are fitted on reactor walls in the dis-, semi- and continuously operated plant,
that the fitted plates have a large bore and can have small bores at the edge,
that a removable device without a plate or with one or more plate(s) is placed in large bores in order to restrict or to close the openings
that the reactor and the plates have deviating round and cylindrical shapes,
that the plates are conical in shape,
that a second discharge valve for sludge removal has been provided at the lowest point for dis-, semi- and continuously operated reactors,
that work is done to set the scale/carbonic acid balance for use in domestic installations from 20° C. and chemical precipitation from 30° C.,
that the reactor has been heat-insulated with the help of insulation materials.

1. A reactor for decalcifying water and simultaneous removal of pollutants and reduction of turbidity comprising:
a base;
a treatment area with feed for the water to be treated;
a discharge area for the treated water;
at least one heating device for the water;
a plurality of fitted plates to deflect the water flow, which are positioned a distance from the base of the reactor;
each fitted plate being formed with a through bore;
a device for opening and closing the bore formed in each fitted plate whereby the upper end of the device is free of a fitted plate;
whereby one or more of the fitted plates is formed with at least one circumferential opening in an edge area thereof and in which heating devices are arranged in the sections of the reactor at a distance from one another and the feed and/or discharge for the water is arranged in the upper and/or lower area of the reactors; and
wherein the fitted plate with only one large bore is positioned above a plate with bores at the edge.

2. The reactor according to claim 1, wherein the reactor is manufactured from stainless steel, steel alloys or thermally resistant material.

3. The reactor according to claim 1 wherein the plates are conical in shape.

4. The reactor according to claim 1 wherein the plates are interconnected with one another and further comprising at least two rods that can then be pushed into the reactor or pulled out of the reactor.

5. A reactor according to claim 1 further comprising a screen in the reactor to prevent discharge of the sediments during the water treatment.

6. (canceled)

7. The reactor at claim 1 further comprising an additional discharge for sediment removal.

8. The reactor at claim 1 in which the through bore is formed in the middle of the fitted plate.

9. A method for decalcifying water and simultaneous removal of pollutants, reduction of turbidity and disinfection in a reaction comprising the steps of:
heating the water, by which the solubility of the CO₂ in the water is reduced and the desorption of the CO₂ is initiated while increasing the pH level;
arranging one or more fitted plates in the reaction area with intensive micro-mixing within the water and on the reactor wall and deflecting the water flow to the reactor wall;
increasing seed crystal formation and growth on the wall, while keeping the heated water at an increased temperature if need be;
removing by turbulence the scale originating and the crusts which have set under the plate(s) and on the heating surfaces;
discharged the water; and
wherein the step of heating the water occurs in sections of the reactor at a distance from one another and at different times and the air and vapor bubbles are made smaller, in order to enable a more intensive exchange of material in more heated areas and to produce a fractioned crystallization coupled with inoculation and secondary crystallization in less heated areas.
